(19) United States
(12) Patent Application Publication
(10) Pub. No.: US 2008/0112762 A1
(43) Pub. Date: May 15, 2008

(54) Method And Device For Constructing A Pipeline With An In-Line Or Add-On Device From A Pipeline Laying Vessel

(75) Inventors: Cornelis van Zandwijk, Waddinxveen (NL); Robert Paul Hovinga, 'S Gravenzande (NL)

Correspondence Address: HOFFMANN & BARON, LLP, 6900 JERICHO TURNPIKE, SYOSSET, NY, 11791, US

(73) Assignee: HEEREMA MARINE CONTRACTORS NEDERLAND B.V., Leiden (NL)

(21) Appl. No.: 11/719,346

(22) PCT Filed: Nov. 17, 2005
(86) PCT No.: PCT/NL05/00798

§ 371 Date: Jul. 13, 2007

Related U.S. Application Data
(60) Provisional application No. 60/628,118, filed on Nov. 17, 2004.

(51) Int. Cl. F16L 1/12

(52) U.S. Cl. 405/166; 405/184.4

(57) ABSTRACT

The invention relates to a method and device for constructing a pipeline with an in-line or add-on device from a pipeline laying vessel, the method comprising the steps of: (a) suspending the pipeline from a clamping device on the vessel; (b) connecting an in-line or add-on device to the pipeline above the clamping device; (c) moving at least part of the clamping device away from the pipeline to provide clearance at the pipeline; (d) lowering the pipeline by a pipeline, deployment device until the in-line or add-on device has moved beyond the clamping device.

### FIELD OF THE INVENTION

The present invention relates to a method and device for constructing a pipeline with an in-line or add-on device from a pipeline laying vessel. Pipelines are widely applied in the off-shore industry where in water, pipelines are laid on a seabed by a pipeline laying vessel. In the art, the pipeline is usually laid on the seabed from the pipeline laying vessel by a pipeline laying assembly on board the vessel. The pipeline is lowered from the pipeline laying vessel and is moved relative to the vessel in the direction of the seabed during the laying of the pipeline.

Often, the pipeline is spooled off a reel which is located on board the vessel. The pipeline may also be constructed from individual pipe sections during the laying of the pipeline, for instance in a J-lay mode.

The pipeline is suspended from the pipeline laying vessel and exerts a considerable force on the pipeline laying vessel, and is hence to be firmly held during the laying thereof. For this purpose, the pipeline laying vessel comprises a pipeline deployment device. During normal operation, the pipeline deployment device holds the pipeline and may move the pipeline relative to the vessel, usually slowly and in a controlled fashion, in the direction of the seabed. The pipeline deployment device often comprises one or more devices which are known in the art as tensioners.

The pipeline laying vessel usually also comprises a clamping device. The clamping device is positioned downstream relative to the pipeline deployment device, viewed in the direction in which the pipeline leaves the pipeline laying vessel. The clamping device is constructed to hold the pipeline in situations wherein the pipeline deployment device does not hold the pipeline, for instance when the pipeline deployment device is disengaged from the pipeline or when a cut is to be made in the pipeline below the pipeline deployment device.

In the art, in-line devices often need to be connected in line with the pipeline, in order to be lowered to the seabed together with the pipeline. Such an in-line device may have a cross section which is greater than a clearance provided by the clamping device. A typical in-line device is for instance a manifold section.

In a known pipeline laying method and device, a special procedure is started when an in-line device is to be connected in line with the pipeline and lowered to the seabed.

### DESCRIPTION OF THE PRIOR ART

In a known pipeline laying method, a procedure is developed and used to insert a manifold section into a pipeline. In an initial situation prior to the procedure, the pipeline is held by a tensioner on board the vessel. Next, a clamp which is positioned below the tensioner engages the pipeline and firmly holds the pipeline. The pipeline is subsequently cut above the clamp, so that the clamp holds a free end of the pipeline.

Next, the clamp with the free end of the pipeline is moved to a lifting device holding a manifold section by a winch line, until the pipeline is aligned with the manifold section. The clamp travels on rails. In a subsequent next step a lower end of the manifold section is welded to the free end of the pipeline.

Subsequently, the lifting device lowers the combination of manifold section and pipeline from the vessel in the direction of the seabed. Once the manifold section has been lowered to a position below the clamp, the clamp engages and holds an upper section of the manifold section which now redefines the free end of the pipeline.

Next, the clamp is moved back from the lifting device toward the welding station, into alignment with the remainder of the pipeline which may be wound upon a reel. The free end of this remaining portion is subsequently welded to the free end of the pipeline.

Next, the tensioner is caused to engage and hold the pipeline again, and the clamp is opened and disengaged from the pipeline. The laying of the pipeline is continued and the manifold section is lowered to the seabed.

An example of such a pipeline laying ship is disclosed in U.S. Pat. No. 6,733,208 which is hereby incorporated by reference herein.

This known method and device has a disadvantage in that in order to add the manifold section to the pipeline, the clamp needs to be moved while the pipeline is suspended therefrom. The pipeline exerts a substantial force on the clamp, and hence, the clamp and the rails on which the clamp is moved must be able to withstand a substantial force while the clamp is being moved from the first position to the second position.

### SUMMARY OF THE INVENTION

It is an object of the invention to provide a method and device of constructing a pipeline with an in-line or add-on device, which pipeline is to be lowered to a sea bottom.

This object is reached in a method for constructing a pipeline with an in-line or add-on device from a pipeline laying vessel, the method comprising the steps of:

(a) suspending the pipeline from a clamping device on the vessel;

(b) connecting an in-line or add-on device to the pipeline above the clamping device;

(c) moving at least part of the clamping device away from the pipeline to provide clearance at the pipeline;

(d) lowering the pipeline by a pipeline deployment device until the in-line or add-on device has moved beyond the clamping device.

The pipeline laying vessel may be a barge or a ship.

Preferably, the pipeline laying vessel is dynamically positioned. The pipeline may be launched through a moonpool in the pipeline laying vessel, or on any side of the pipeline laying vessel. The pipeline may be held in a substantial angle to the horizontal when it leaves the pipeline laying vessel. In deep water, the pipeline may be in a substantially upright position near the pipeline laying vessel. The word ‘above’ should be interpreted as: on a side of the clamping device facing away from the seabed. If the pipeline is held t a small angle to the horizontal, the position at which the in-line device or add-on device is connected to the pipeline may not be entirely above the clamping device, but is still on the side of the clamping device facing away from the seabed. Preferably, the speed with which the deployment device moves the pipeline downward is controllably variable.

The pipeline may be spooled from a reel on board the pipeline laying vessel or constructed on board the pipeline laying vessel, for instance in S-lay or J-lay.

An in-line or add-on device can for instance be: a manifold, Wye Sled Assembly (WSA), Pipeline End Terminator (PLET), a template, a field joint, a sealing device for sealing off a free end of a pipeline, a valve, a T-joint, a branch pipe, a pumping device, a suspension support, a pipe section having a greater cross section than the cross section of the pipeline, a pipe section with a connected buoy, or any other device having a cross section which is larger than the cross section of the pipeline itself. The in-line device may be an in-line structure. This list is a non-limiting list, and a person skilled in the art will appreciate that other in-line devices may also exist.

An add-on device can for instance be: a Vortex Induced Vibration (VIV) strake, a buckle arrestor, a control device, a second pipe section installed as a piggyback on a main pipeline, a monitoring device, an anode or a buoyancy element, or any other device connected to the pipeline. The add-on device may be an add-on structure. This list is a non-limiting list, and a person skilled in the art will appreciate that other add-on devices may also exist.

The features of a WSA and a PLET have been described in the OTC paper no. 16632: ‘Design Features for Wye Sled Assemblies and Pipeline End Termination Structures to facilitate Deepwater Installation by the J-Lay Method’, prepared for presentation at the Offshore Technology Conference held in Houston, Tex., U.S.A. on May 3-6, 2004, which publication is incorporated by reference herein.

The in-line or add-on device need not be positioned exactly in line with the main axis of the pipeline, but may be positioned eccentrically from the main axis of the pipeline. Viewed from above, the in-line or add-on device may project out of the cross section of the pipeline along the whole circumference of the cross section, or along a part of the circumference of the pipeline.

Different embodiments of the clamping device are possible.

The clamping device may comprise a number of hydraulic cylinders held by a frame, as known in the art. The clamping device may also comprise a number of wedges, as known in the art.

The pipeline deployment device can be a pipeline tensioning device, preferably comprising at least one tensioner. Other forms of pipeline deployment devices than tensioners are also possible, as long as the pipeline deployment device is capable of holding the suspended pipeline, and also capable of longitudinally moving the pipeline relative to the vessel.

The clearance which is provided by moving at least part of the clamping device away from the pipeline must be sufficient to allow the in-line or add-on device to pass by the clamping device.

Preferably, prior to step (b) a step (al) is performed of separating the pipeline by a pipeline separating device positioned along a lay path between the clamping device and the pipeline deployment device into a first pipeline section extending from the clamping device toward the seabed and a second pipeline section held by the pipeline deployment device, thereby obtaining two pipeline ends spaced from each other, wherein step (b) further comprises connecting the in-line or add-on device to the pipeline ends.

This provides the advantage of allowing in-line devices, such as a Wye Sled Assembly (WSA) or a Pipeline End Termination (PLET), to be connected in-line with the pipeline.

Preferably, after separating the pipeline, the first pipeline section and the second pipeline section are moved away from one another, for providing space for the in-line or add-on device to be inserted there between.

This provides the advantage that with a simple movement the required space can be created.

Preferably, after the separating of the pipeline, the second pipeline section is moved upwards over a predetermined distance by the pipeline deployment device to provide space for the in-line to be inserted there between. In this way, in-line or add-on devices of various sizes can be positioned in-line or add-on with the first and second pipeline section.

Preferably, in step (a1) the pipeline is separated in a first and second pipeline section by performing the steps of:

(a1a) making a first separation and a second separation in the pipeline at a predetermined distance from one another; and

(a2a) removing a length of pipeline between the first and second separation.

This provides the advantage that the pipeline does not need to be moved upward after the making of the separation. The length of pipeline which is to be removed can be chosen such that the in-line or add-on device fits neatly between the first and second pipeline section.

Preferably, prior to step (b) the in-line or add-on device is moved, in particular by a handling device, from a first position at a distance from the pipeline to a second position in close proximity to the pipeline.

In the second position the in-line device or add-on device can be directly connected or means of a respective connection device or coupling device known in the art. Preferably the moving by the handling device is an automated process, thus further enhancing the reliability of construction. Preferably, the moving by the handling device is a pre-programmed movement, wherein certain parameters of the movement are adjustable and/or controllably variable. Such parameters be: the speed of movement, the horizontal and vertical start position, the horizontal and vertical end position. Other parameters may also be varied controllably. Preferably, the handling apparatus comprises a programmable control device for varying the parameters of movement.

Preferably, the in-line or add-on device is moved to a second position aligned with the first pipeline section and the second pipeline section.

This provides the advantage that the in-line or add-on device is at exactly the required location for subsequently connecting it to the pipeline, thereby facilitating rapid construction.

Preferably, prior to the connecting of the in-line device or add-on device to the pipeline, the in-line or add-on device is moved along a trajectory of movement which extends substantially perpendicular to the main axis of the pipeline. This provides an efficient aligning of the in-line or add-on device with the first and second pipeline section, and further enhances an automation of the process.

Preferably, in step (c) the clamping device is moved into a position in which the pipeline and the clamping device are positioned on opposite sides of a plane which extends substantially parallel to the main axis of the pipeline. In this way, a large clearance is provided at the pipeline. Preferably, the plane is located at a substantial distance from the pipeline.

Preferably, during step (c) at least one part of the clamping device is moved away from the pipeline along a trajectory of movement which is substantially perpendicular to the main axis of the pipeline. This is an efficient way of retracting the clamping device away from the pipeline.

The invention also relates to a pipeline laying vessel for constructing a pipeline comprising an in-line or add-on device, the pipeline laying vessel comprising:

a clamping device positioned on board the vessel along a lay path, the clamping device being configured for holding the pipeline;

a clamp moving device configured for moving at least part of the clamping device away from the lay path for providing clearance at the pipeline;

a pipeline deployment device positioned along the lay path at a distance from the clamping device, the pipeline deployment device being configured for lowering the pipeline; and

at least one pipeline processing device configured for connecting the in-line or add-on device to the pipeline.

The lay path is the trajectory that is followed by the pipeline on board the pipeline laying vessel during the laying of the pipeline.

Preferably, the at least one processing device comprises a pipeline separating device, the pipeline separating device being configured for separating the pipeline into a first pipeline section held by the clamping device and extending toward the seabed and a second pipeline section held by the pipeline deployment device. This provides the advantage of allowing an in-line device or add-on device to be connected to a pipeline spooled off a reel.

Preferably, the pipeline laying vessel further comprises a a handling device configured for moving the in-line or add-on device from a first position at a distance from the lay path to a second position close to the lay path.

Preferably, the handling device is configured for moving the in-line or add-on device to a second position aligned with the first pipeline section and the second pipeline section.

Preferably, the clamping device comprises at least a first and a second gripping part, wherein at least one gripping part is configured to be retracted from the lay path by the clamp moving device, for providing clearance at the pipeline.

Preferably, the clamping device is configured to be moved away from the lay path by the clamp moving device.

Preferably, the at least one processing device comprises a welding station. In a processing device comprising a welding device, both the functions of separating and connecting may be performed. The processing device may also be equipped to perform other functions, such as Automated Ultrasonic Testing (AUT) and Field Joint Coating (FJC).

Preferably, two processing devices are provided, positioned at a distance from one another along the lay path, the processing devices being configured for making a first separation and a second separation in the pipeline at a predetermined distance from one another.

Preferably, the two processing devices are configured for simultaneously making the first and second separation in the pipeline. This enables carrying out the operation at a higher speed.

Preferably, at least one processing device is retractable away from the lay path, for providing clearance at the lay path. If the in-line device is welded to two ends of two respective pipeline sections as explained hereinabove, the lower welding station may form an obstacle for the in-line device. If the lower welding station is retractable, the in-line device can pass this welding station on its way downward.

Preferably, the clamping device is movably mounted on at least one rail, for allowing the clamping-device to be moved away from the lay path for providing clearance around the pipeline. A rail is a suitable means for moving the clamping device away from the lay path. Preferably, the handling device is configured for conveying the in-line or add-on device to and from the lay path. Preferably, the handling device is movably mounted on at least one rail.

Preferably, the handling device comprises an alignment organ, in particular a stop, for aligning the in-line or add-on device with the first and second pipeline sections. The alignment organ facilitates a rapid movement of the in-line device or add-on device to the second position.

Preferably, the clamping device is adapted to be split in two or more clamping parts, wherein the clamping parts are adapted to be retracted clear of the lay path. This provides an efficient way of retracting the clamping device. Each clamping part may be movably mounted on a separate rail.

Preferably, the clamping device is adapted to be partially retracted so as to provide a predetermined, limited clearance at the lay path.

Preferably, the processing device is positioned along the lay path between the clamping device and the deployment device. This provides a technically reliable configuration for the pipeline laying assembly.

Alternatively, the pipeline laying vessel comprises:

a clamping device positioned on board the vessel along a lay path, the clamping device being configured for holding the pipeline;

a pipeline deployment device positioned along the lay path at a distance from the clamping device in the direction of a seabed, the pipeline deployment device being configured for lowering the pipeline; and

a deployment moving device configured for moving at least part of the pipeline deployment device away from the lay path for providing clearance at the pipeline;

at least one pipeline processing device positioned between the clamping device and the pipeline deployment device and configured for connecting the in-line or add-on device to the pipeline.

This configuration is also capable of constructing a pipeline with an in-line or add-on device.

### BRIEF DESCRIPTION OF THE DRAWINGS

FIGS. 1, 2, 3, 4, 5, 6 and 7 show schematic front views of a pipeline laying vessel;

FIG. 8 shows a schematic front view of a pipeline laying assembly;

FIG. 9 shows a schematic side view of the pipeline laying vessel with an add-on device;

FIG. 10 shows a schematic perspective view of an embodiment of a clamping device;

FIG. 11 shows a schematic front view of a pipeline laying assembly comprising a reel;

FIG. 12 shows a schematic top view of a clamping device;

FIG. 13 shows a schematic top view of a tensioning device;

FIG. 14 shows a schematic cross-sectional side view of a tensioning device;

FIG. 15a shows a schematic view of a Pipeline End Termination (PLET);

FIGS. 15b and 15c show schematic views of a Wye Sled Assembly (WSA);

FIG. 16 shows a photograph of a Wye Sled Assembly (WSA);

FIG. 17 shows another photograph of a Wye Sled Assembly (WSA); and

FIG. 18 shows a front view of another embodiment of the invention.

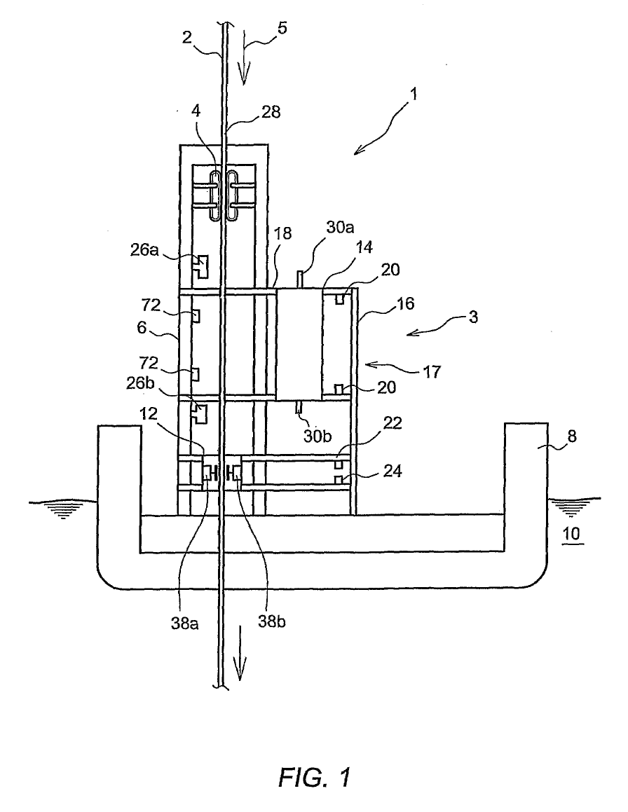

Referring to FIGS. 1, 2, 3, 4, 5, 6 and 7 a pipeline laying vessel 1 is shown, comprising a pipeline laying assembly 3. A pipeline 2 is shown during the laying thereof. The pipeline 2 extends through the pipeline laying assembly 3 along a lay path 28. The pipeline 2 may be spooled off a reel (not shown) on board the pipeline laying vessel 1. The pipeline laying vessel is a ship, comprising a hull 8, and is shown in water 10. Other types of vessels such as a barge are also possible. The pipeline 2 is suspended from the pipeline laying vessel 1, and held by a pipeline deployment device in the form of a tensioning device 4. A frame 16 is provided, whereupon rails 18 and rails 22 are mounted. On rails 18, an in-line device 14 is movably mounted. The in-line device 14 may roll on wheels (not shown) or may slide over the rails 18 on slide blocks (not shown). A driving device 20 is provided for moving the in-line device 14 on rails 18. The rails 18 and driving device 20 form part of a handling device 17 for handling and moving the in-line device 14. The in-line device 14 may be moved from a first position at a distance from the lay path 28 to a second position in line with the lay path 28. In FIG. 1, the in-line device 14 is shown in the first position.

On the rails 22, a clamping device 12 is movably mounted. Drive 24 is provided for moving the clamping device 12 back and forth in a horizontal direction from a first position at a certain distance from the lay path 28 to a second position in line with the lay path 28. The in-line device 14 may roll on wheels (not shown) or slide on slide-blocks (not shown) over rails 22. The in-line device 14 comprises a first, upper pipe section 30a at the upper side thereof and a second, lower pipe section 30b at a lower side thereof. The pipe sections 30a and 30b have the same diameter as the pipeline 2 and are configured to be connected thereto.

The driving devices 20, 24 may be electrical, pneumatic, hydraulic or any other suitable driving device.

The clamping device 12 comprises a first clamping part 38a and a second clamping part 38b. The clamping device may comprise more than two clamping parts.

Two connecting devices in the form of work stations 26a and 26b are shown in a position at a close distance from the lay path 28.

During operation, the pipeline is laid in the direction of arrow 5, moving downwards through the pipeline laying assembly 3 towards a seabed (not shown). The tensioning device 4 holds the pipeline 2 and slowly moves it downwards at a controlled speed. The clamping device 12 is in an open position, with the clamping parts 38a, 38b at a predetermined distance from the pipeline 2.

When an in-line device or add-on device is to be connected to the pipeline 2, separations 32a, 32b in the pipeline 2 are performed by the work stations 26a, 26b. For this end, the work stations 26a, 26b comprise welding devices (not shown).

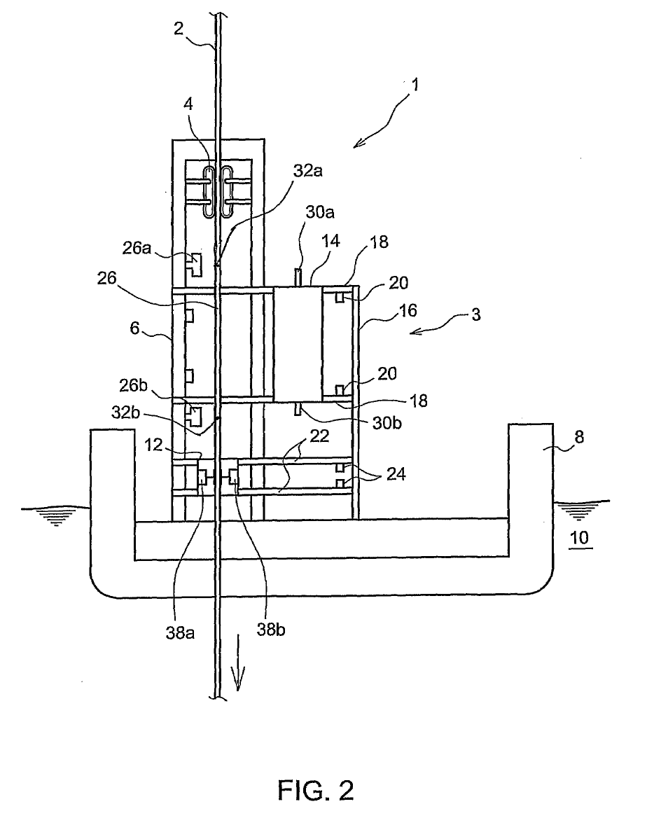

Referring to FIG. 2, the pipeline laying vessel 1 is shown in a next stage of the pipeline laying process wherein separations 32a and 32b have been performed, thereby creating a length of pipeline 2c which can be removed from the lay path 28. Prior to the making of the separations 32a, 32b, the clamping device 12 has been closed, thereby firmly holding the pipeline 2.

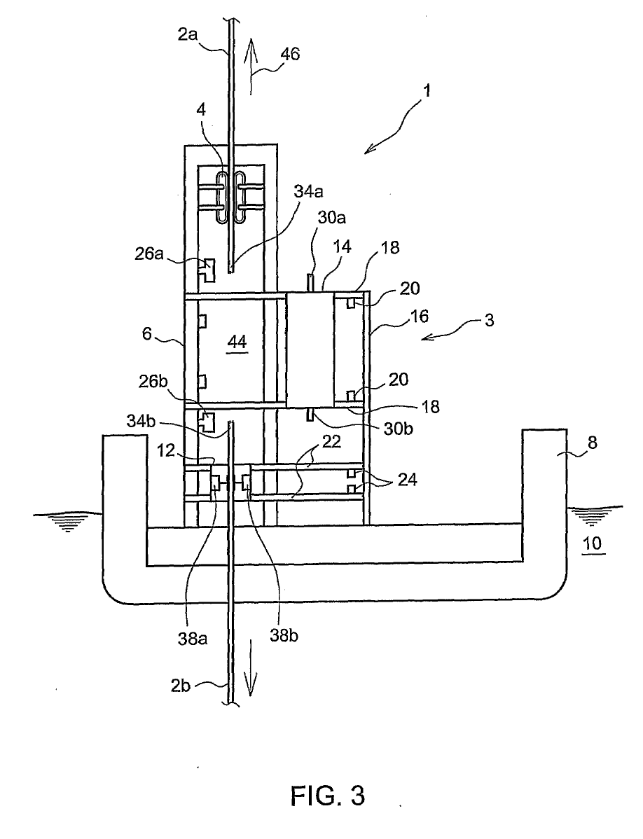

Referring to FIG. 3, the length of pipeline 2c (not shown) has been removed from the pipeline 2, thereby creating a first section of pipeline 2b held by, and suspended from, the clamping device 12, and a second pipeline section 2a, held by the tensioning device 4. During this stage of the operation, the clamping device 12 remains closed.

A clearance 44 is created between a first end 34a of the first pipeline section 2a and a second end 34b of the second pipeline section 2b, at the place where the pipe length 2c previously was.

Alternatively, only one separation is made in the pipeline 2. In that case, the pipeline section 2a will be moved upwardly, in order to create the required clearance 44 between the ends 34a and 34b of the respective pipeline sections 2a and 2b.

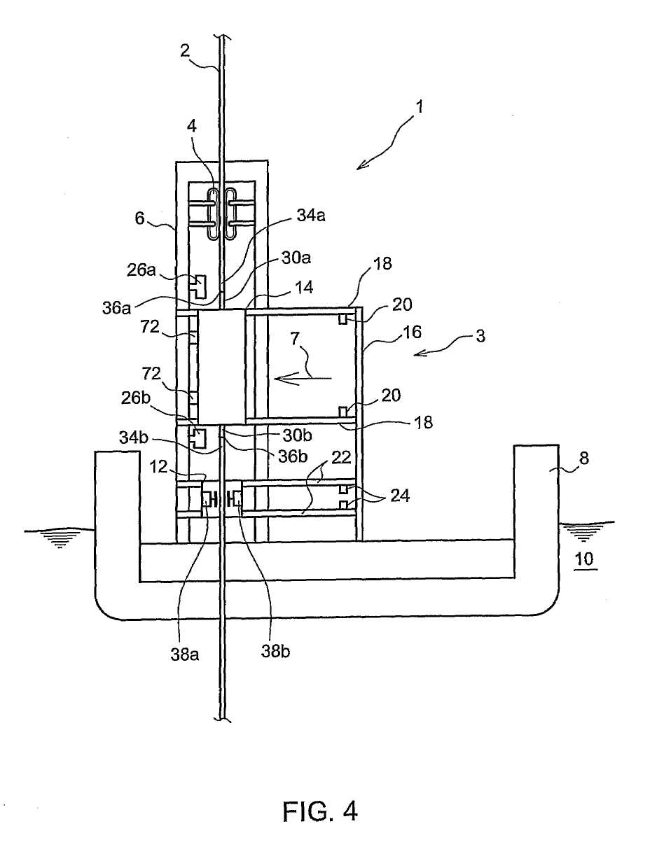

Referring to FIG. 4, the pipeline laying vessel 1 is shown in a next stage of the operation, wherein the in-line device 14 is moved by driving device 20 over the guide rails 18 in the direction of arrow 7 from the first position at a distance from the pipeline 2 to a second position aligned with the pipeline 2. Alignment organs 72 in the form of stops are provided to stop the in-line device in the required position.

Work stations 26a and 26b weld the in-line device 14 to the upper pipeline section 2a and to the lower pipeline section 2b and thus create respective pipeline connections 36a, 36b.

After the in-line device 14 is connected to the respective pipeline ends 34a, 34b by the respective upper and lower pipe sections 30a, 30b, the clamping device 12 is opened. The pipeline with the in-line device is now suspended from the tensioning device 4.

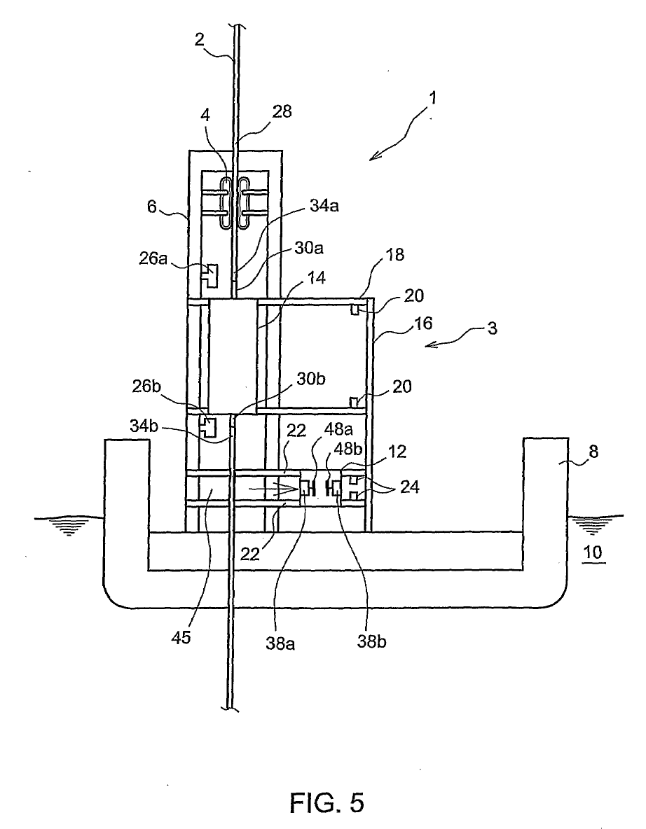

Referring to FIG. 5, the pipeline laying vessel 1 is shown in a next stage wherein the clamping device 12 is moved by driving device 24 over rails 22 away from the lay path 28 and pipeline 2. A clearance 45 is thereby created around the lay path 28 and pipeline 2. If necessary, work station 26b is also retracted away from the lay path 28 and pipeline 2 in order to provide clearance for the in-line device 14. The work station 26 may be movably mounted on rails (not shown) and provided with a driving device (not shown) for this end.

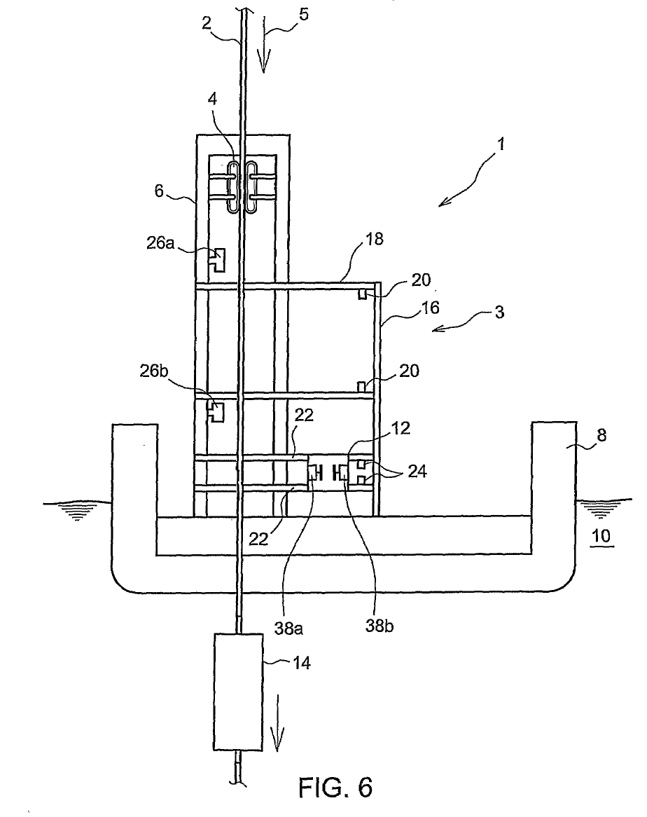

Referring to FIG. 6, the in-line device 14 is shown on its way downwards toward the seabed (not shown). The tensioning device controllably lowers the pipeline 2 with the in-line device 14.

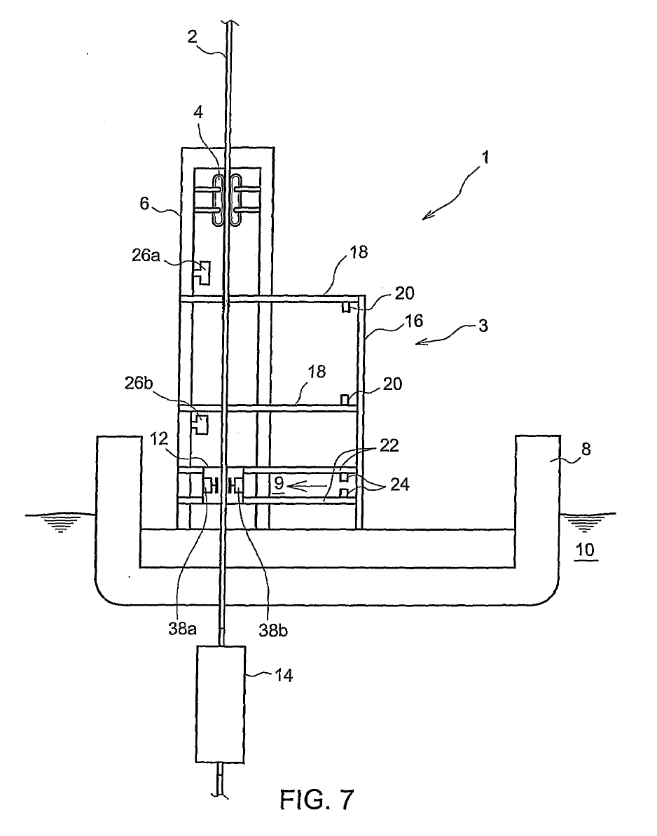

Referring to FIG. 7, the pipeline laying vessel 1 is shown in a next stage wherein the clamping device 12 is moved back in the direction of arrow 9 in its working position, aligned with the pipeline 2. The handling device 17 is now ready to receive a next in-line device 14 (not shown) or add-on device (not shown).

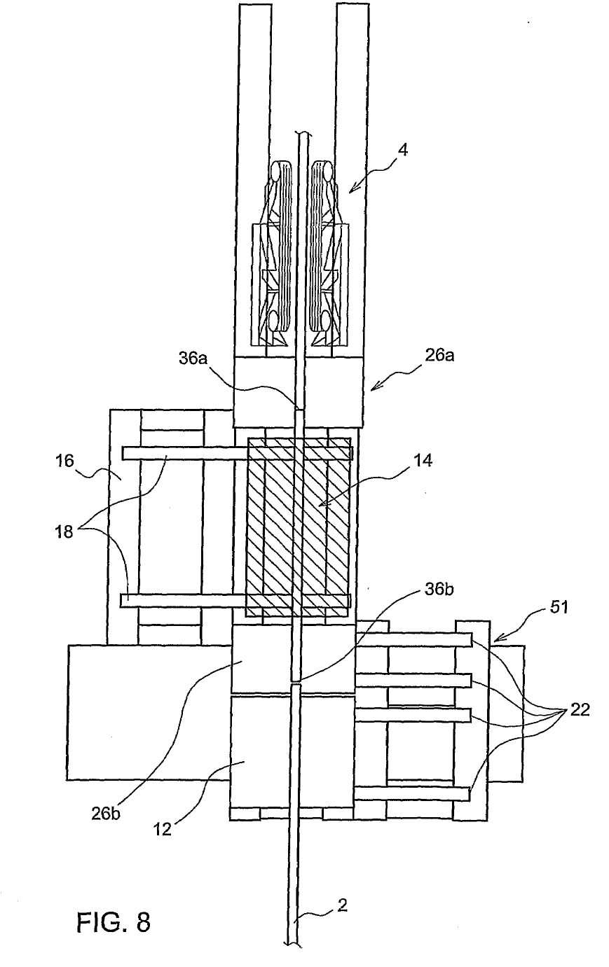

Referring to FIG. 8, a pipeline laying assembly 3 is shown. The upper work station 26a and lower work station 26b are configured for performing the functions of welding, Automated Ultrasonic Testing (AUT) and Field Joint Coating (FJC). The in-line device 14 can also be an in-line structure. A clamp parking support 51 is provided for allowing the clamping device 12 to be positioned at a distance from the pipeline 2. An in-line structure parking support is provided for allowing the in-line device to be positioned at a distance from the pipeline 2. Four rails 22 are provided to support the clamping device 12.

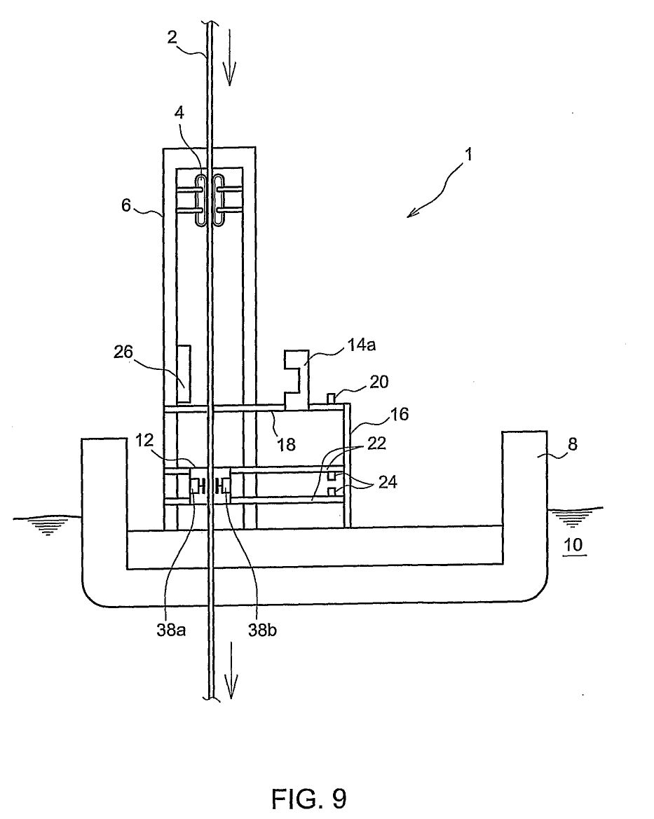

Referring to FIG. 9, an add-on device 14a is shown in a position ready to be connected to the pipeline 2. For connecting the add-on device 14a, no separation needs to be made in the pipeline 2. Work station 26 is provided for connecting the add-on structure 14a to the pipeline 2, for instance by a welding operation. Other kinds of connections, for instance by means of a known connection device, are also possible. The operation is further conducted in a similar way as shown in FIGS. 1 through 7.

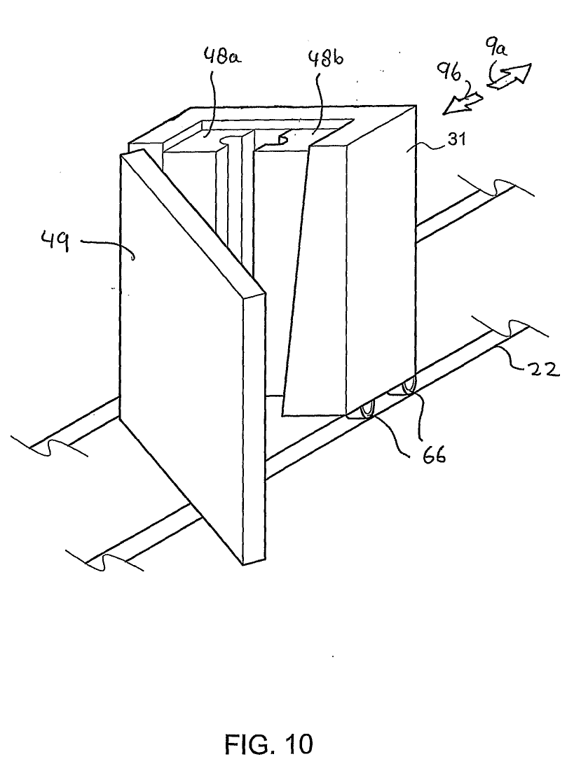

Referring to FIG. 10, an embodiment of a clamping device 12 is shown. The clamping device 12 comprises movable gripping parts 48a, 48b in the form of wedges. The gripping parts 48a, 48b can be moved by an actuation device (not shown). An opening device in the form of a door 49 is provided for opening the clamping device 12, for enabling the clamping device 12 to be moved away from the pipeline 2.

The clamping device 12 comprises wheels 66 on which the clamping device can roll over rails 22 to and from the pipeline 22, in the direction of arrows 9a, 9b. A driving device (not shown) is provided for moving the clamping device 12.

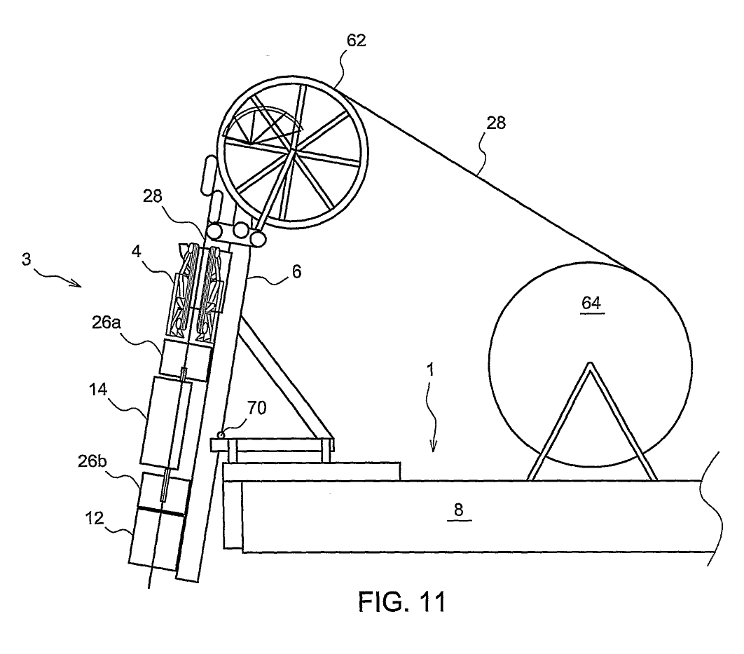

Referring to FIG. 11, a pipeline laying assembly comprising a reel 64. The pipeline 2 is wound on the reel 64. A guiding wheel 62 is provided that guides the pipeline 28 in a curved trajectory from the reel towards the tensioning device 4 and further downwards. The frame 6 on which the pipeline laying assembly 3 is mounted, is pivotally connected to the hull 8 of the pipeline laying vessel 1. The frame 6 may be rotated around pivot axis 70, for varying the angle of the lay path 28 with the horizontal. Such a pipeline laying assembly 3 may be mounted on the stern, forward, port or starboard side of the pipeline laying vessel 1, or in a moonpool in the pipeline laying vessel 1.

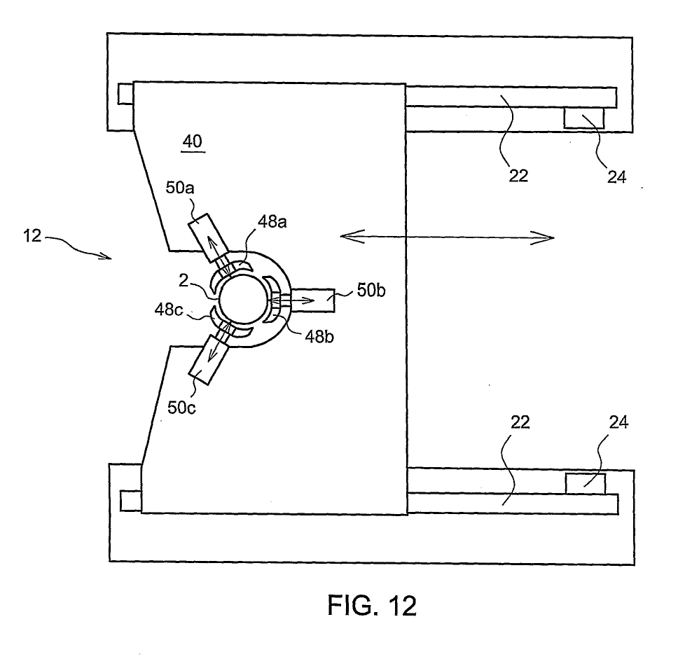

Referring to FIG. 12, a carriage 40 is shown on rails 22. The carriage 40 forms part of the clamping device 12. Clamps 50a, 50b and 50c are mounted on the carriage 40, for allowing the clamping device to be moved away from the pipeline 2, for providing clearance around the pipeline 2. A drive 24 is provided for moving the clamping device 12. The clamps 50a, 50b and 50c comprise respective gripping parts 48a, 48b and 48c, that are configured to contact the pipeline 2. The gripping parts 48a, 48b and 48c are hydraulically actuated, and can be moved over a predetermined, limited distance. If the gripping parts 48a, 48b and 48c are retracted from the pipeline 2 (or lay path 28), a limited clearance is provided at the pipeline 2. In-line devices having a cross-section that fits through this limited clearance may be lowered to the seabed (not shown) without the need of fully retracting the clamping device 12 by moving the carriage 40 away from the pipeline 2.

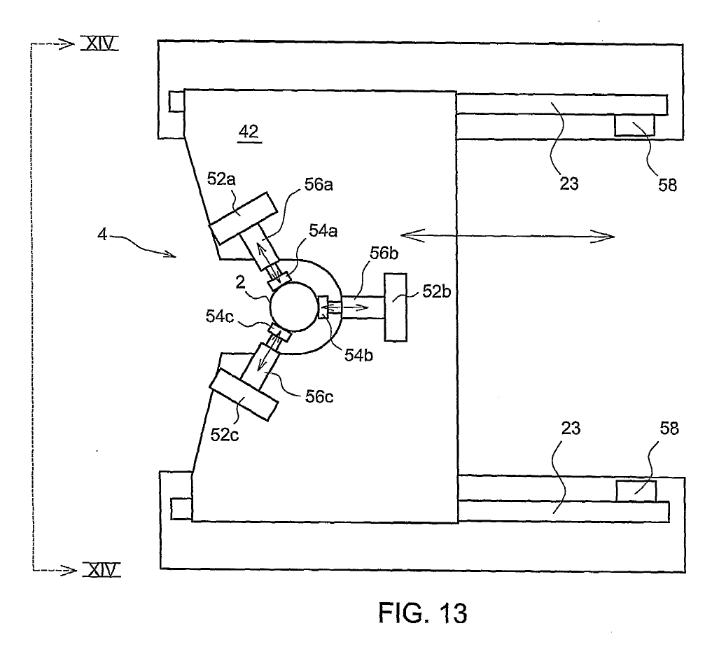

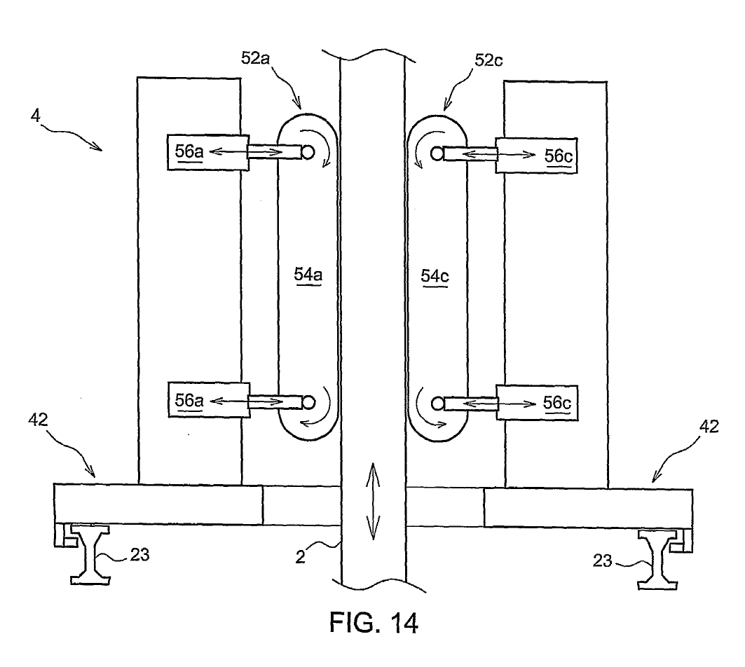

Referring to FIGS. 13 and 14, a tensioning device 4 is shown, comprising a carriage 42 movably mounted on rails 23. The carriage 42 has a substantial U-shape. In this embodiment, the tensioning device is also retractable away from the lay path 28. In case an in-line device 14 for instance is wound with the pipeline 2 on a reel (not shown) the tensioning device 4 can be retracted away from the lay path 28. If the tensioning device 4 is retracted, the pipeline 2 will be held by the clamping device 12 or by other tensioning devices (not shown).

Alternatively, the clamping device 12 may be a tensioning device 4. In this case, the tensioning device 4 performs the same function as the clamping device 12. The tensioning device 4 comprises tensioners 52a, 52b, 52c. Each tensioner 52a, 52b, 52c comprises a respective tensioning track 54a, 54b, 54c, and respective actuation devices 56a, 56b and 56c. When the tensioning track 54a, 54b, 54c are retracted from the pipeline 2 by the respective actuation devices 56a, 56b and 56c a clearance is provided around the pipeline 2, enabling the carriage 42 to be moved over the rails 23, away from the pipeline 2, providing a clearance around the pipeline 2.

The tensioners 52a and 52b comprise driving devices (not shown) for moving the pipeline 2 upwards and downwards through the tensioning device 4.

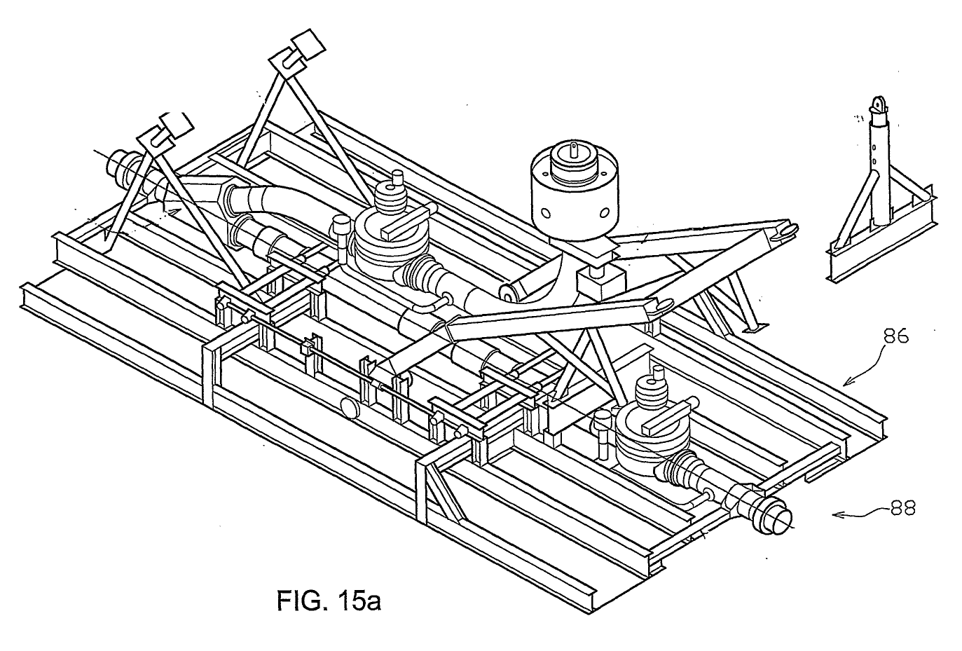

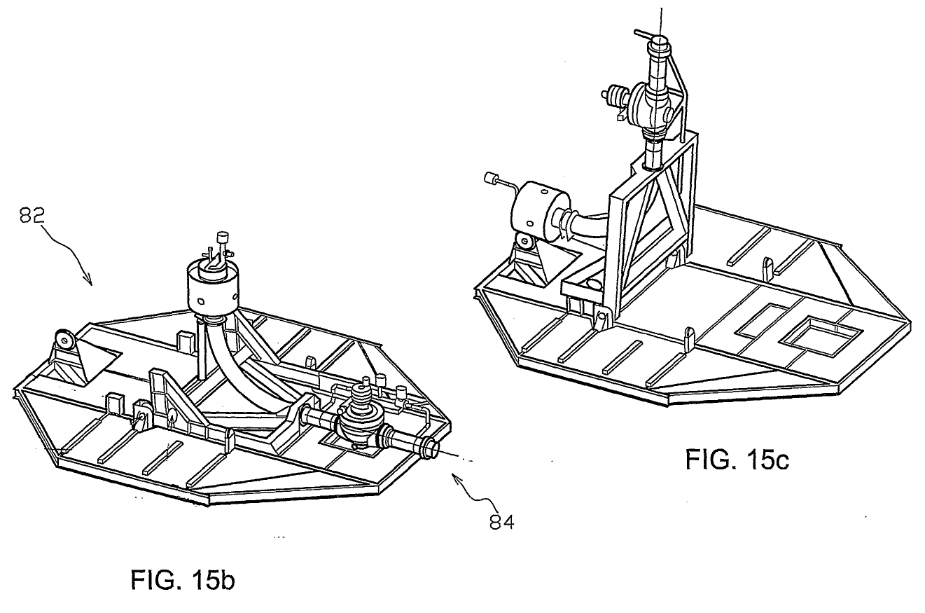

Referring to FIG. 15a, a Pipeline End Termination Device (PLET) 82 is shown, comprising a trunk line 88 for connection to the pipeline 2.

Referring to FIGS. 15b and 15b Wye sled assemblies are shown, comprising a base trunk 84 for connection to the pipeline 2.

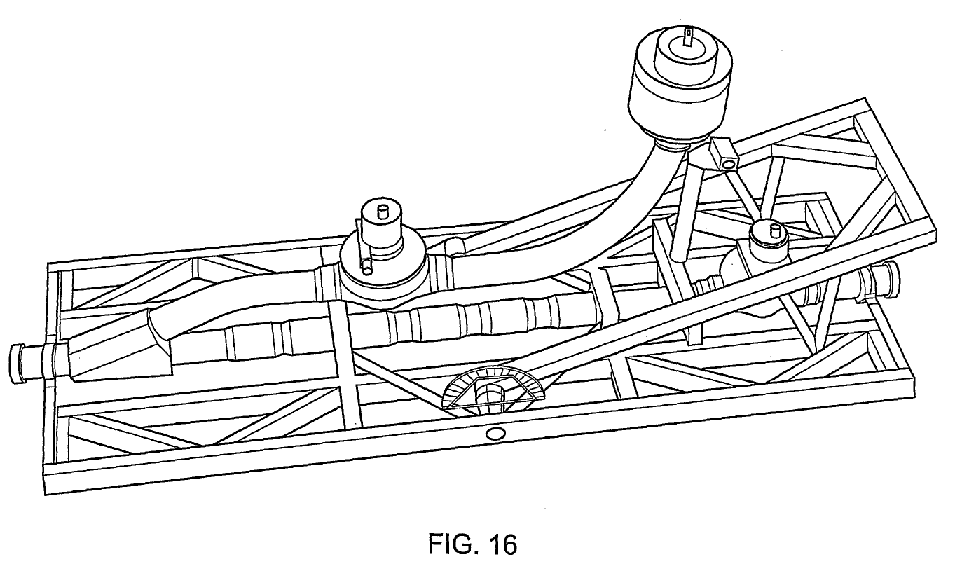

Referring to FIG. 16, a photograph of an embodiment of a Wye Sled Assembly (WSA), which is an example of an in-line device 14.

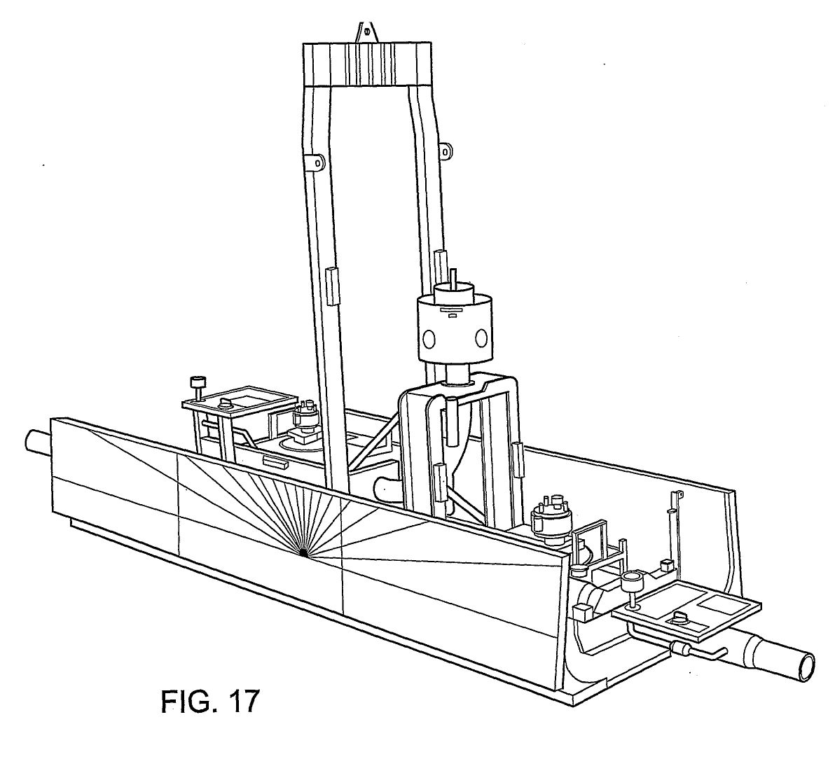

Referring to FIG. 17, a photograph of another embodiment of a Wye Sled Assembly (WSA) is shown.

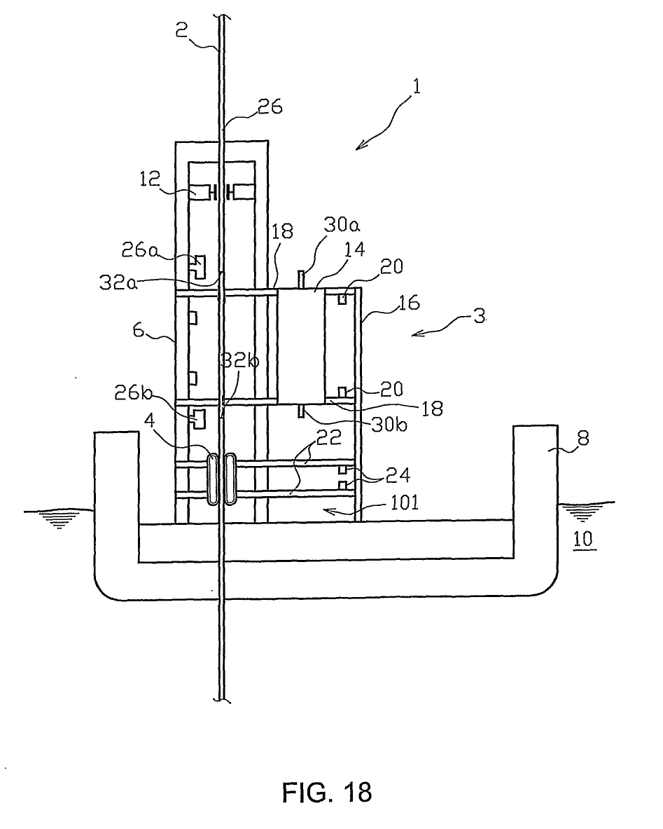

Referring to FIG. 18, an alternative embodiment of the invention is shown, with the deployment device 4 positioned at a distance from the clamping device 12, in the direction of the seabed (not shown). This is essentially an inverted version of the embodiments described hereinabove. The deployment device 4 is movably mounted on rails 22 and configured to be retracted away from the lay path 28by a deployment moving device 101, for providing clearance for the in-line device 14.

1-74. (canceled)

75. A method for constructing a pipeline with an in-line or add-on device from a pipeline laying vessel, the method comprising the steps of
(a) suspending the pipeline from a clamping device on the vessel;
(b) moving the in-line or add-on device from a first position at a distance from the lay path which is followed by the pipeline on board the vessel during the laying of the pipeline to a second position close to the lay path, the second position being located between the clamping device and a pipeline deployment device, and subsequently connecting the in-line or add-on device to the pipeline above the clamping device;
(c) moving at least part of the clamping device away from the pipeline to provide clearance at the pipeline; and
(d) lowering the pipeline by the pipeline deployment device until the in-line or add-on device has moved beyond the clamping device.

76. The method of claim 75, further comprising the step of:
(a1) separating prior to step (b) the pipeline by a pipeline separating device positioned along a lay path between the clamping device and the pipeline deployment device into a first pipeline section extending from the clamping device toward a seabed and a second pipeline section held by the pipeline deployment device, thereby obtaining two pipeline ends spaced from each other;
wherein step (b) further comprises connecting the in-line or add-on device to the pipeline ends.

77. The method of claim 76, wherein alter the separating of the pipeline the first pipeline section and the second pipeline section are moved away from one another, for providing a clearance for the in-line or add-on device to be inserted there between.

78. The method of claim 76, wherein after the separating of the pipeline the second pipeline section is moved upwardly by the pipeline deployment device to provide a clearance for the in-line or add-on device to be inserted there between.

79. The method according to claim 76, wherein in step (a1) the pipeline is separated in a first and second pipeline section by performing the steps of:
(a1a) making a first separation and a second separation in the pipeline at a predetermined distance from one another; and
(a1b) removing a length of pipeline between the first and second separation.

80. The method of claim 75, wherein the in-line or add-on device is moved to the second position aligned with the first pipeline section and the second pipeline section.

81. The method of claim 75, wherein prior to step (b) the in-line or add-on device is moved along a trajectory of movement which extends substantially perpendicular to the main axis of the pipeline.

82. The method of claim 75, wherein in step (c) the clamping device is moved into a position in which the pipeline and the damping device are positioned on opposite sides of a plane which extends substantially parallel to the main axis of the pipeline.

83. The method of claim 75, wherein in step (c) at least one part of the clamping device is moved away from the pipeline along a trajectory of movement which is substantially perpendicular to the main axis of the pipeline.

84. A pipeline laying vessel for constructing a pipeline with an in-line or add-on device, the pipeline laying vessel comprising:
a clamping device positioned on board the vessel along a lay path, the clamping device being configured for holding the pipeline,
a clamp moving device configured for moving at least part of the clamping device away from the lay path for providing clearance at the pipeline;
a pipeline deployment device positioned along the lay path at a distance from the clamping device, the pipeline deployment device being configured for lowering the pipeline;
a handling device configured for moving the in-line or add-on device from a first position at a distance from the lay path which is followed by the pipeline on board the vessel during the laying of the pipeline to a second position close to the lay path, the second position being located between the clamping device and a pipeline deployment device, and
at least one pipeline processing device configured for connecting the in-line or add-on device to the pipeline when the in-line or add-on device is in the second position.

85. The pipeline laying vessel of claim 84, wherein the at least one processing device comprises a pipeline separating device, the pipeline separating device being configured for separating the pipeline into a first pipeline section held by the clamping device and extending toward the seabed and a second pipeline section held by the pipeline deployment device.

86. The pipeline laving vessel of claim 84, wherein the handling device is configured for moving the in-line or add-on device to a second position aligned with the first pipeline section and the second pipeline section.

87. The pipeline-laying vessel of claim 84, wherein the clamping device comprises at least a first and a second gripping part, wherein at least one gripping part is configured to be retracted from the lay path by the clamp moving device, for providing clearance at the pipeline.

88. The pipeline-laying vessel of claim 84, wherein the clamping device is configured to be moved away from the lay path by the clamp moving device.

89. The pipeline laying vessel of claim 85, wherein the at least one processing device comprises a welding station.

90. The pipeline laying vessel of claim 85, wherein two processing devices are provided, positioned at a distance from one another along the lay path, the processing devices being configured for making a first separation and a second separation in the pipeline at a predetermined distance from one another.

91. The pipeline laying vessel of claim 90, wherein the two processing devices are configured for simultaneously making the first and second separation in the pipeline.

92. The pipeline laying vessel of claim 90, wherein at least one processing device is retractable away from the lay path, for providing clearance at the lay path.

93. The pipeline laying vessel of claim 84, wherein the clamping device is movably mounted on at least one rail, for allowing the clamping device to be moved away from the lay path for providing clearance around the pipeline.

94. The pipeline laying vessel of claim 84, wherein the handling device is configured for conveying the in-line or add-on device to and from the lay path.

95. The pipeline laying vessel of claim 94, wherein the handling device is movably mounted on at least one rail.

96. The pipeline laying vessel of claim 84, wherein the handling device comprises an alignment organ, in particular a stop, for aligning the in-line or add-on device with the first and second pipeline sections.

97. The pipeline laying vessel of claim 84, wherein the clamping device is adapted to be split in two or more clamping parts, wherein the clamping parts are adapted to be retracted clear of the lay path.

98. The pipeline laying vessel of claim 84, wherein the clamping device is adapted to be partially retracted so as to provide a predetermined, limited clearance at the lay path.

99. The pipeline laying vessel of claim 84, wherein the processing device is positioned along the lay path between the clamping device and the deployment device.

100. A pipeline laying vessel for constructing a pipeline with an in-line or add-on device, the pipeline laying vessel comprising: a clamping device positioned on board the vessel along a lay path, the clamping device being configured for holding the pipeline suspended fi-om the clamping device;
a pipeline deployment device positioned along the lay path at a distance from the clamping device in the direction of a seabed, the pipeline deployment device being configured for lowering the pipeline; and
a deployment moving device configured for moving at least part of the pipeline deployment device away from the lay path for providing clearance at the pipeline;
a handling device configured for moving the in-line or add-on device from a first position at a distance from the lay path which is followed by the pipeline on board the vessel during the laying of the pipeline to a second position close to the lay path, the second position being located between the clamping device and a pipeline deployment device; and
at least one pipeline processing device positioned between the clamping device and the pipeline deployment device and configured for connecting the in-line or add-on device to the pipeline when the in-line or add-on device is in the second position.
